(19) United States
(12) Patent Application Publication
(10) Pub. No.: US 2025/0335427 A1
(43) Pub. Date: Oct. 30, 2025

(54) SYSTEMS AND METHODS FOR SIMULATING RANGE QUERIES IN A KEY/VALUE STORE

(71) Applicant: Stripe, Inc., South San Francisco, CA (US)

(72) Inventors: Hemal Mukeshkumar Shah, Sunnyvale, CA (US); Karan Vohra, Sammamish, WA (US); Shashi Madappa, Campbell, CA (US); Fei Hu, Issaquah, WA (US); Alexandre Desjardins, Verdun (CA); Yufei Hu, Foster City, CA (US)

(21) Appl. No.: 18/647,229

(22) Filed: Apr. 26, 2024

(51) Int. Cl. G06F 16/23; G06F 16/22; G06F 16/27

(52) U.S. Cl. CPC G06F 16/2379; G06F 16/2255; G06F 16/27

(57) ABSTRACT

A method and apparatus for executing data access requests in a distributed storage system are described. The method can include receiving, by a router node from a service application, a data access request to read data from one of a plurality of data storage nodes, the data access request comprising a key associated with the data, and generating a hash value from the key. The method can further include determining a data storage node of the plurality of data storage nodes that can satisfy the data access request based at least in part on the hash value generated from the key. The method further includes transmitting, to the data storage node, the data access request with the hash value, and receiving the data, the data storage node accessing the data using the hash value. The method can also include transmitting the data to the service application.

### BACKGROUND

Service provider systems can provide various services to user systems over computing networks. The services provided can include database transaction processing services, media access services, customer relationship management services, data management services, and medical services, as well as combinations of such services. Modern computing techniques employed by many service provider systems typically involve deploying the functions of the service provider systems as distributed services. That is, each service may be responsible for a discrete set of functions, and the services and associated functions operate autonomously or in conjunction with one another to provide the overall functionality of a service provider system. By dividing the overall functionality of service provider systems in this way, the services may be distributed to different computing systems, multiple instances of the same services used concurrently, etc. to adapt to system load, network connectivity issues, and service instance failure, as well as other technical challenges associated with distributed service provider systems.

In each of the above service provider systems, users of a service provider system often interact with the service provider system via database transactions. For example, a user may initiate one of many types of database transactions supported by the service provider system. Then, the services of the distributed service provider system will execute functions of the service provider system to implement the requested database transaction. For example, the database transaction may be a media access transaction or a telecommunications transaction, resulting in the invocation of one or more services of the service provider system to process the requested database transaction.

During each of the operations performed by a service provider system involved with a database transaction, the service provider system services may generate and store data, or seek to access existing data associated with the service or the database transaction. The data may include data associated with transaction bookkeeping purposes, record keeping purposes, regulatory requirements, end-user data, service system data, or third-party system data, as well as other data that may be generated or accessed during the overall processing of the database transaction. The service provider systems may perform billions of transactions, resulting in an enormous volume of data generation and quantities of access operations of the service provider system services.

To efficiently perform database transactions by the services of the service provider system, many technical challenges arise. For example, services provider systems typically employ distributed storage techniques for storing the enormous amounts of data generated and retrieved during database transactions. However, in distributed storage systems, the distribution of data in storage locations can be random, including storage of data in storage locations remote to a requesting user. In such cases, for high request-per-second services and/or users, the obtaining of data in response to such high-volume requests from random storage locations can result in high amounts of latency. Furthermore, in distributed data storage system that rely on key-value storage, data storage may not reflect a time that the data was generated. Therefore, such key-value data stores may not support range-based queries, which can lead to sub-optimal performance. As a result, solutions to many technical challenges are presented for fast, efficient, and reliable processing of data access requests in a distributed storage system.

### BRIEF DESCRIPTION OF THE DRAWINGS

The present disclosure will be understood more fully from the detailed description given below and from the accompanying drawings of various embodiments, which should not be taken to limit the embodiments described and illustrated herein, but are solely for explanation and understanding.

FIG. 1 is a block diagram of an exemplary system architecture for a service provider system that improves data access efficiency and reliability to distributed data storage.

FIG. 2 is a block diagram of a process for a router node and a cache data node of a service provider system to exchange data.

FIG. 3 is a block diagram of an embodiment of a service provider system architecture with a router node interacting with a data cache data node to satisfy data access requests with zone affinity and/or range query requests.

FIG. 4 is a flow diagram of a process for executing a data access request from a service application to a data storage node, as routed by a router application.

FIG. 5 is a diagram of an example data record comprising a partial key that can contribute to a range query.

FIG. 6 is a flow diagram of an embodiment of a process for executing a data access request from a service application, to a cache data node, as directed by a router application.

FIG. 7 is a flow diagram of an embodiment of a process for executing a data access request from a service application, to a cache data node, as directed by a router application.

FIG. 8 is a flow diagram of a process for executing, in an embodiment, a data access request by a router application, received from a service application, to a data storage node.

FIG. 9 is an embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Often, though not always, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that these and similar terms are to be associated with the appropriate physical quantities and are merely convenient labels applied to these quantities. Unless specifically stated otherwise, it is appreciated that throughout the description, discussions utilizing terms such as “receiving,” generating,” “determining,” transmitting,” “accessing,” or the like, refer to the actions and processes of a computer system, or similar electronic computing device, that manipulates and transforms data represented as physical, e.g., electronic, quantities within the computer system's registers and memories into other data similarly represented as physical quantities within the computer system memories or registers or other such information storage, transmission, or display devices.

The embodiments discussed herein may also relate to an apparatus for performing the operations herein. This apparatus may be specially constructed for the designated purposes, or it may comprise a general-purpose computer selectively activated or reconfigured by a computer program stored in the computer. Such a computer program may be stored in a computer readable storage medium, such as, but not limited to, floppy disks, optical disks, CD-ROMs, and magnetic-optical disks, read-only memories (ROM), random access memories (RAM), EPROMS, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the designated method steps. The designated structure for a variety of these systems will appear from the description below. In addition, the embodiments discussed herein are not described with reference to any particular programming language. It will be appreciated that a variety of programming languages may be used to implement the teachings as described herein.

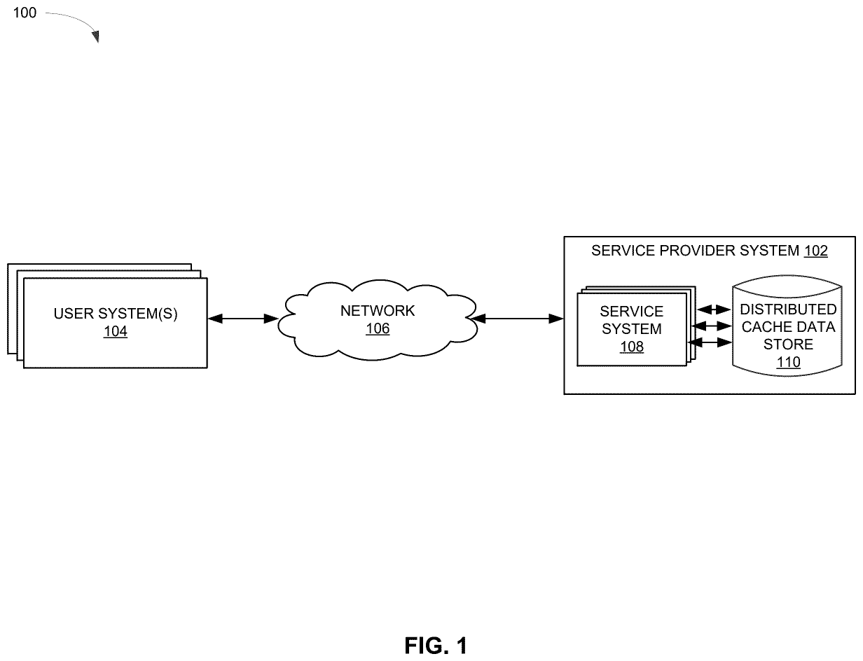

FIG. 1 is a block diagram of an exemplary system architecture 100 for a service provider system that improves the efficiency and reliability of data access to distributed data storage. In some embodiments, the system architecture 100 includes service provider system 102 and one or more end-user system(s) 104. In some embodiments, one or more of the end-user system(s) may be mobile computing devices, such as smartphones, tablet computers, and smartwatches, as well as desktop computer systems, laptop computer systems, and server computer systems. The service provider system 102 and one or more of the end-user system(s) 104 may also be one or more computing devices, such as server computer systems or desktop computer systems.

The embodiments discussed herein may be utilized by a plurality of different types of service provider systems, such as commerce platform systems and payment processing systems, card authorization systems, banks, and other systems seeking to perform zero downtime topology updates of distributed data stores, as discussed in greater detail below. Furthermore, any system seeking to store data in a distributed fashion, such as medical information systems, customer relationship management systems, or media storage and distribution systems, may use and/or extend the techniques discussed herein to improve the efficiency and reliability of data access request processing in distributed storage systems. However, to avoid obscuring the embodiments discussed herein, the operations and techniques to improve the efficiency and reliability of data access request processing in distributed storage systems may use examples of a commerce platform service provider system to illustrate and describe the embodiments of the present invention, and are not intended to limit the application of the operations and techniques described herein from applicability to other systems.

The service provider system 102 and end-user system(s) 104 may be coupled to a network 106 and communicate with one another using any of the standard protocols, including secure communication protocols, for the exchange of information. In some embodiments, the service provider system 102 and end-user system(s) 104 may run on a local area network (LAN) and may be incorporated into the same physical or logical system or instantiated on different physical or logical systems. Alternatively, the service provider system 102 and end-user system(s) 104 may reside on different LANs, wide area networks (WANs), or cellular telephone networks, that may be coupled together via the Internet but separated by firewalls, routers, and other network devices. In some embodiments, service provider system 102 may reside on a single server, be distributed among multiple servers, coupled to other devices via a public network, e.g., the Internet, or a private network, e.g., a LAN. It should be noted that various other network configurations can be used, such as hosted configurations, distributed configurations, or centralized configurations.

In some embodiments, service provider system 102 provides processing services to one or more end-user system(s) 104. For example, service provider system 102 may manage accounts held at the commerce platform, run database transactions initiated at end-user system(s) 104, clear transactions, provide payouts to agents, manage accounts held at the service provider system 102, as well as perform other services that utilize distributed data storage, as discussed in greater detail herein. Each of these functions may be carried out by one or more service system(s) 108 of the service provider system 102. In some embodiments, service provider system 102 distributes the services it provides to end-users among one or more service systems(s) 108 so that the processing of the services may be distributed. In some embodiments, such a service distribution enables service provider systems to scale based on load, demand, hardware issues, geographic needs, expanded service offerings, or many other reasons.

In some embodiments, end-user system(s) 104 access the service systems 108 of service provider system 102 by network-based messaging, such as application programming interface (API) based messaging by which end-user system(s) 104 request a service by messaging the request to one or more of the service systems 108. In some embodiments, service systems 108 in turn, generate messages to other service systems 108, generate data associated with the requested service for storage in distributed cache data store 110 or access data stored in distributed cache data store(s) 110 that is needed to process the requested service. Thus, each requested service operation can generate, store, access, write, delete, modify, or otherwise interact with data stored at the distributed cache data store 110. In some embodiments, such data may originate from the end-user system(s) 104, e.g., user supplied data, and/or may be data associated with a requested service that is generated by a service system 108.

Service provider system 102 can provide numerous services to end-user systems(s) 104. For example, if service provider system 102 is a commerce platform, the services may include running database transactions for end-users, managing accounts, performing tax accounting services as a result of the various database transactions, performing data control and management of data, or providing platform hosting services. In some embodiments, each of these services are initiated at the request of an end-user system 104 or by another service 108. In some embodiments, end-user system(s) 104 invoke the services of service system(s) 108 to execute billions of service transactions. Therefore, in some embodiments, the number of data access requests generated by the service systems(s) 108 is enormous, and the number of communications between the service systems 108 and the distributed cache data store 110 is at least as large. As a result, the messaging used to execute the data access requests can consume a vast amount of network bandwidth, and can be susceptible to reliability issues.

Because of this volume, in some embodiments, service provider system 102 employs an architecture in which a service node that provides one of the services 108 and a router node that dispatches data access requests to an appropriate node in the distributed cache data store 110 are bound together, such that data access requests are directed to a cache data store in a particular zone using zone-based affinity. In some embodiments, data accesses to a cache data store are performed using a partial key mechanism, in which a hash is generated on a portion of a data block's key, allowing a bulk retrieval of data having the same partial key with a single read request, or bulk get. In some embodiments, the partial key includes a time component, such that multiple records can be written to and retrieved from a set of storage buckets, each bucket comprising a set of time-bounded records.

In some embodiments, distributed cache data store 110 comprises cache memory of a distributed data storage system, such as a Memento™ data storage system. In some embodiments, distributed cache data store 110 is a cache storage in which data accesses, e.g., data being generated and stored, read, overwritten, edited, copied, or moved, are processed on the machines/nodes that compose the distributed cache data store 110. In some embodiments, the distributed cache is a pool of the random-access memory (RAM) associated with multiple physical resources, e.g., computing systems implementing the service systems 108, that serves as an in-memory data store to provide fast access to the data stored within the distributed cache data store 110. In some embodiments, the use of distributed cache data store(s) 110 to manage data accessed by the service systems 108 benefits both end-user system(s) 104 and service systems 108 as data access requests may be handled more quickly and consume less network bandwidth.

As will be discussed in greater detail below, the volume of data access requests can consume a vast amount of network bandwidth to support the exchange of billions of data access request messages with the distributed cache data store 110. Furthermore, because, in some embodiments, the data access requests are handled by the distributed cache data store 110 (which may be remote to the service system 108 originating the request) the greater the number of network messages between service system 108 and a data storage node of distributed cache data store 110, the more likely the data access request will fail. For example, each data access message can encounter network congestion, network failure, dropped packets, etc., reducing the reliability of the distributed cache data store 110 and thus the services of the service provider system 102. The architecture discussed below, in which a service 108 and a router that dispatches data access requests to an appropriate node in the distributed cache data store 110 are bound together, such that data access requests are directed to a cache data store in a particular zone using zone-based affinity can reduce network latency and improve hits to the cache by grouping data in a particular cache data store.

Similarly, a partial key mechanism discussed in greater detail herein, in which a hash is generated on a portion of a data block's key, e.g., a user-id and an account-id, allowing a bulk retrieval of data having the same partial key with a single read request, or bulk get, can improve system performance by reducing the number of individual record retrievals. As an example, retrieval of 1000 records with unique key/values hashes could require 1000 queries. Alternatively, if those 1000 records contained partial keys with 12 unique hashes, 12 queries might retrieve those same 1000 records, resulting in less computing effort, faster data retrieval, and reduced bandwidth consumption. Furthermore, in some embodiments, each of those 1000 records may be identified by the same partial key, such that retrieval of those 1000 records can be performed vi a single query.

In some embodiments, the partial key includes a time component, such that multiple records can be written to and retrieved from a set of storage buckets, each bucket comprising a set of time-bounded records. Such a structure allows a range query to be performed in a distributed key-value data storage system, by calculating, from the partial keys, one or more hashes corresponding to the set of records comprising the time bounds. Furthermore, such range queries are executable without additional tables of key-value locations, where such tables may become out of sync with tables maintained at storage nodes, occupy additional memory, and require additional communications to consult if making a range query. Additional technical benefits and advantages of the architecture of the present application will also become apparent in the discussion below.

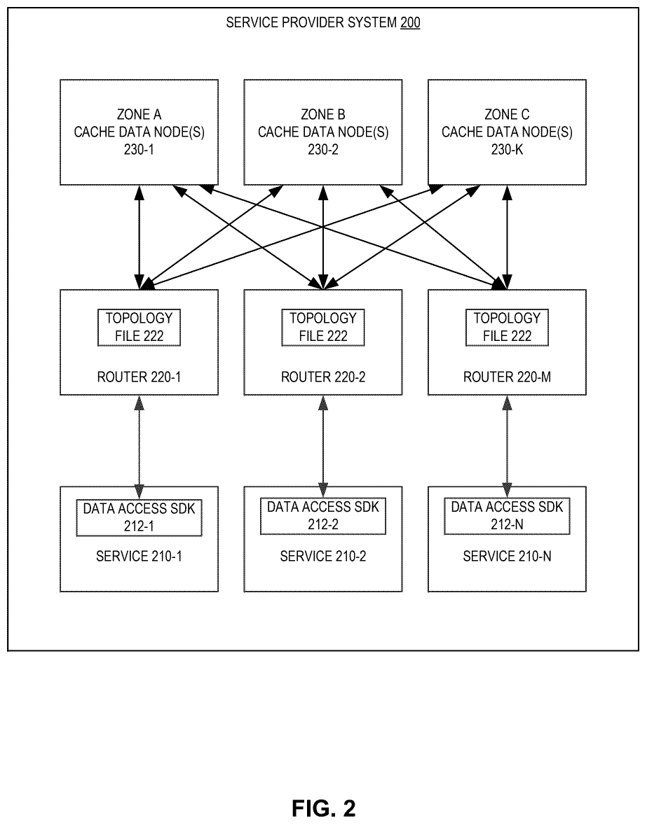

FIG. 2 is a block diagram of an embodiment of a service provider system 200 architecture for services accessing cache data nodes via routers. In some embodiments, service provider system 200 is analogous to service provider system 102, and provides additional details for service provider system 102 discussed above in FIG. 1.

In some embodiments, service provider system 200 includes a plurality of services (e.g., services 210-1, 210-2, through 210-N), a plurality of routers (e.g., routers 220-1, 220-2, through 220-M), and a plurality of cache data nodes (e.g., nodes 230-1, 230-2, and 230-K). The services and routers, in some embodiments, include processing logic that may comprise hardware (circuitry, dedicated logic, etc.), software (executed on a general-purpose computer system or a dedicated machine), or firmware. The cache data nodes maintain their data primarily in memory, minimizing the impact of repetitive data access operations on an underlying database, such as MongoDB. Their distributed architecture allows for horizontal scaling across multiple nodes, ensuring consistent performance even under heavy loads. In some embodiments, the cache data nodes include logic to respond to and execute data access requests, e.g., those originating from the services.

In some embodiments, service 210 corresponds to service system 108 of FIG. 1. In some embodiments, each service 210 is responsible for executing one or more functions of the service provider system 200. For example, a service 210 may respond to an end-user request or command (not shown), a request or command of another service, or a periodic and automatic job executed by the service. In some embodiments, in the course of executing the function, the service 210 will access a data access software development kit (SDK). The data access software development kit (SDK) 212 comprises a set of data access functions that enable the service to read, write, or otherwise interact with a router 220 to access a cache data node 230. The data access SDK may define one or more API function calls, remote procedure calls (RPCs), or other remote communication techniques, enabling get, post, put, delete, or other data access functions, that are used by the service 210 to access data. In some embodiments, such function calls may be part of a data access software library, such as that provided by the Memento™ distributed data storage system.

In some embodiments, service system data, such as that accessed by services 210-1 through 210-N, is stored in a distributed cache. In some embodiments, the distributed cache includes cache data node(s) 230-1 through 230-K. Each of the cache data node(s) 230-1 through 230-N may be part of a zone of cache data nodes, such as Zone A cache data node(s) 230-1, Zone B cache data node(s) 230-2, and Zone C cache data node(s) 230-k. In some embodiments, each cache data node zone includes multiple machines and/or nodes providing in-memory storage at a geographic region or data center. In some embodiments, each cache data node or cache data node zone may be a single tenancy cluster of cache data nodes, such that only data of a specific service or specific end-user system is stored within the respective cache data node or cache data node zone. In some embodiments, data stored for a service or end-user may be distributed amongst the nodes associated with that end-user/service, and duplicate data maintained in redundant cache data node(s), to ensure data availability. Many node configurations are possible with the embodiments discussed herein.

In some embodiments, the machines providing the cache data node(s) 230 are physical machines, virtual machines executing on a single physical machine, or a combination thereof. For example, a web services provider system may provide physical computing resources for services 210 and associated cache memory can be pooled from those physical resources for cache data node(s) 230. In some embodiments, each cache data node 230 is locatable by an identifier of the cache data node, such as an internet protocol (IP) address of the cache data node, indicating a location within the web services provider system's physical resources where data is stored.

In some embodiments, the cache data nodes 230 provide data storage for the services 210, as discussed herein. Each cache data node may store data in a tabular form, as well as other forms, accessible or indexed by data key (e.g., a value derived from or assigned to data). Then, data accesses may be implemented as key based data access requests, generated by the data access SDKs 212, with the data values locatable within the cache data node(s) 230 by the associated keys. If implemented as tabular data stores, the keys may be arranged as rows of tabular data, with the associated data values of each key stored in a column for a given key's row. Then, in some embodiments, a data access request generated by a data access SDK 212 may be serviced based on an IP address where data is stored and a key value of the data associated with the request.

In some embodiments, routers 220 are systems that lie between the cache data nodes 230 and the services 210. In some embodiments, each router 220 includes routing logic that determines where data is stored amongst the cache data nodes based on one or more topology files 222. In some embodiments, each topology file 222 stores, for each service and/or end-user, an ordered set of IP addresses of the cache data nodes in which data is stored for that service/end-user. In some embodiments, the topology files 222 are identical across the routers 220 to ensure consistent routing decisions among the routers. In some embodiments, the ordered set of IP addresses of the cache data nodes is predefined, includes the number of cache data nodes used by the service/end-user, and identifies each cache data node by IP address within the given ordering. In some embodiments, using the ordered listing of IP addresses of the cache data nodes and the total number of nodes, a deterministic data distribution technique, such as a jump hash technique, can calculate, based on a key and total number of nodes for a service/end-user, a preferred node of the ordered listing. That is, in some embodiments, a key value and a number of nodes can be input into the jump hash calculation, which outputs a deterministic node selection. For example, if there are three cache data nodes associated with a service, and a key value of 1234 is input with the total number of cache data nodes, the jump hash technique will always return the same resulting node, such as node 230-1, for the combination of key and number of total cache data nodes. The IP address of the cache data node and the associated storage location of the data associated with the key can then be determined. In some embodiments, the jump hash technique performs regular distribution, so that data written to nodes is distributed in an even fashion. In some embodiments, the topology file 222 provides a mapping of each service/end-user (e.g., key, ID, name, etc.) to its related cache data nodes (IP address, clusters, regions, etc.) for handling data access requests.

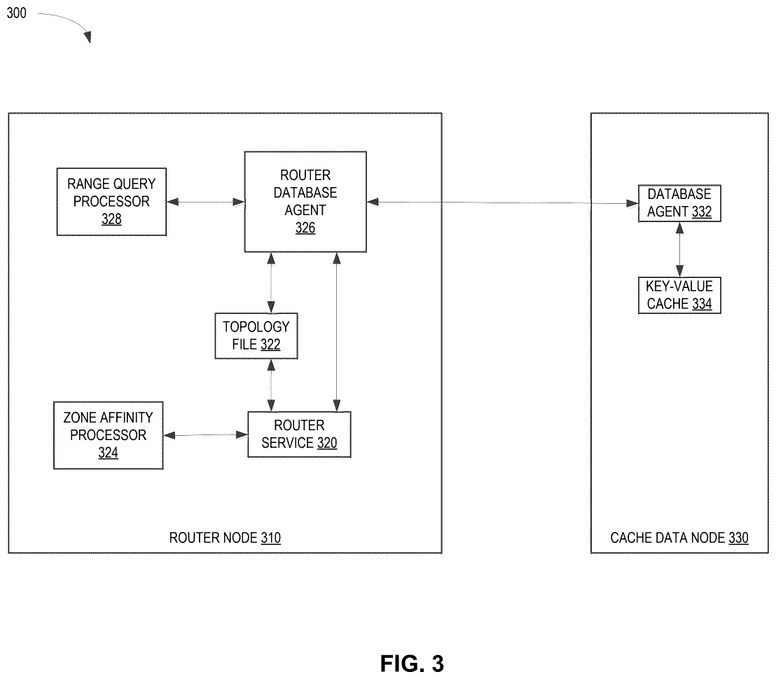

FIG. 3 is a block diagram 300 of an embodiment of a service provider system architecture with a router node 310 interacting with a data cache data node 330 to satisfy data access requests with zone affinity and/or range query requests. Block diagram 300 involves processing logic that may comprise hardware (circuitry, dedicated logic, etc.), software (such as is run on a general-purpose computer system or a dedicated machine), firmware, or a combination. In some embodiments, block diagram 300 involves processing logic executed at a router node 310 and a cache data node 330. In some embodiments, router node 310 corresponds to router 220 of FIG. 2 and cache data node 330 corresponds to cache data node 230 of FIG. 2.

In some embodiments, service nodes, router nodes, and cache data nodes are implemented at one or more web services computing systems, cloud computing systems, etc., and may be physically, logically, geographically, or otherwise distributed. Thus, the service nodes, router nodes, and cache data nodes may be physically implemented in different zones within a local or wide area network. Due to this distribution, as discussed herein, routing of data access requests can be performed within and/or between zones as determined by routing applications.

Furthermore, although FIG. 3 shows only a single router node and cache data node, as illustrated and discussed herein, some embodiments may comprise a plurality of cache data nodes and router nodes distributed across the physical resources of one or more web services providers. In some embodiments, router nodes and cache data nodes may be allocated and deallocated based on data access system loads. Furthermore, in some embodiments, the router nodes and cache data nodes are distributed across one or more data centers, and in some embodiments, are grouped per service system and/or end-user providing single tenancy cache data node clusters. However, to avoid obscuring the present invention, FIG. 3 shows how a router node 310 and a cache data node 330 cooperatively perform zone-based affinity routing, bulk record retrieval (or “gets”), and range queries against a key/value data store.

In some embodiments, cache data node 330 comprises an in-memory database cache, in which key-value cache 334 is maintained. In some embodiments, key-value cache 334 includes logic that is responsible for maintaining an in-memory key-value store of chunks of arbitrary data (strings, objects) from the results of database calls to a backing data store and executing data accesses to the data store in response to requests. As discussed above, in some embodiments, the cache data node 330 is associated with an IP address specifying a location of the cache data node within the distributed storage system. Furthermore, cache data node 330 can store at least a portion of service system data for a service/end-user within the key-value cache 334.

As part of executing its function, in some embodiments, a service system will provide a router service 320 with the key of the data to be accessed and the action/function to be performed on the data, e.g., read, write, overwrite, delete. The router service recognizes one or more API function calls, such as get, post, put, or delete, that can be used to access service data, and which use the key and requested action generated by the service system. In some embodiments, such function calls implemented by the router service 320 use a data access software library, such as that provided by the Memento™ distributed data storage system and embed the key, requested data operation, service application identifiers, user or service initiating the request, user group identifiers, and other identifiers associated with the generation of the data access request message.

In some embodiments, router service 320 receives a data access request from a service system. In some embodiments, such a service system can correspond to service system 108 of FIG. 1 or service 210 of FIG. 2. The service system is omitted from FIG. 3 for clarity. In some embodiments, router service 328 is a Memento™ memrouter service, which consumes and responds to data access requests from service systems. In some embodiments, the data access request comprises information identifying the submitting end-user or service system.

In some embodiments, router service 320 examines the topology file 322 to identify candidate cache data nodes for the data access request. In some embodiments, topology file 322 corresponds to topology file 222 of FIG. 2. In some embodiments, router service 328 will use the topology file to deterministically identify the cache data node 330 to which a data access request should be directed, based on the end-user or service making the request, and if multiple cache data nodes are available, an ordering of those cache data nodes as listed within topology file 322. As discussed herein, router service 328 may use the jump hash technique for deterministic and even distribution of data amongst a set of cache data nodes 330 based on a key value of data, a number of cache data nodes 330 associated with a service, and an ordering of those cache data nodes 330.

In some embodiments, the cache data nodes 330 support at least three copies of cached data, in three different availability zones. In some embodiments, an availability zone comprises a data center building. In some embodiments, the three availability zones may be geographically distributed to avoid the risk of simultaneous loss of all three data centers due to, e.g., power loss. However, in some embodiments, the three availability zones are sufficiently close to router nodes 310 to obviate any latency issues with respect to communication between router nodes 310 and cache data nodes 330.

In some embodiments, router service 320 submits a zone request to zone affinity processor 324. In some embodiments, zone affinity processor 324 attempts to identify a particular availability zone, a local zone, designated as a preferred cache data node for the end-user or service making the data access request. In some embodiments, the zone affinity processor 324 uses a portion of the information identifying the submitting end-user or service system in the data access request to determine a local zone to receive the data access request.

In some embodiments, with the information from topology file 322 and zone affinity processor 324, router service 320 submits the data access request to router database agent 326. Database agent 326, in some embodiments, is a Memento™ memcar database agent, such as a sidecar service or a caching agent, that submits API based data access requests to a database agent 332 executing on a cache data node 330 and receives data in response.

In some embodiments, prior to sending the data access request to the database agent 332 on cache data node 330, router database agent 326 submits the data access request to range query processor 328. In some embodiments, range query processor 328 examines the data access request for opportunities to apply partial key information in the data access request to optimize the data access request and reduce the number of distinct key values submitted to the database agent 332.

Generally, database tables support queries through the use of (sometimes several) indexes against columns (and combinations of columns) in the database tables. Each column supporting an index can be referred to as a key. However, every insert, update, or delete operation applied against the table can require an update to each index. The time required for these index operations can significantly affect the total time for the insert, update, or delete operation. A range query can use one of these indexes to identify records for which the value of the column lies between a first value and a second value.

Key-value database tables, by comparison, typically possess a single key with data stored as a single value. Queries use the key to retrieve the associated data. In some embodiments, duplicate keys allow multiple records to be stored and retrieved in association with a particular key. In some embodiments, the key is hashed to simplify identification within the database.

In contrast with a database supporting multiple indexes on multiple columns and combinations of columns, a key-value database does not typically support a range query. Performing a range query can potentially require a number of records to be individually retrieved and their keys evaluated for satisfaction of the range, with a large number of records discarded. Each of these discarded records required time and computing resources to be retrieved, adding to the overall time and cost of the data retrieval.

A partial key is an attribute or set of attributes that can only identify some records, not all, within a table. Hashing a partial key can subsequently produce a value that uniquely identifies a set of records, allowing only records with values to be retrieved. As an example, a partial key could include an account number A and a time component B. Hashed into a single value, a query could retrieve, in a single operation, those records associated with account number A and time component B, effectively resulting in a range operation. In an embodiment, by storing information associated with account number A in a cache data node in a single zone, retrieval of a time range of records associated with account number A could be accomplished by a single read operation against a single data store, vastly reducing database transaction time and computing cost. In some embodiments, hashes of different partial keys are able to support a variety of range queries.

Another mechanism for reducing query compute costs and network overhead is storing and retrieving data in bulk. In some embodiments, a bulk put comprises storing multiple data values with a single key. In some embodiments, to store a value of “value1” to the record with the key “key1”:

put key1 value1 mode=append;
The value of “key1” is now “value1”.
get key1 returns value1;

Three elements can then be added to the value field:

put key1 value2 mode=append;
put key1 value3 mode=append;
put key1 value4 mode=append;

The value of key1 is now the aggregation of the four values:
get key1 returns [value1, value2, value3, value4];

In some embodiments, to store a value of “value5” to the record

with the key “key2”:

put key2 value5 mode=append;
The value of “key2” is now “value5”.
get key2 returns value5;

Three elements can then be added to the value field:

put key2 value6 mode=append;
put key2 value7 mode=append;
put key2 value8 mode=append;

The value of key2 is now the aggregation of the four values and can be retrieved with a single get operation:
get key2 returns [value5, value6, value7, value8];

A bulk get operation allows the values associated with multiple keys to be retrieved in a single operation:

bulkGet key1, key2, key3, key4;
returns { key1: [value1, value2, value3, value4], key2: [value5,
value6, value7, value8] }

In some embodiments, puts and gets can combine different types of values, e.g., integers, strings, and floats:

put agg_key1 X1_int;
put agg_key2 X2_string;
put agg_key3 X3_float;

A bulk get operation also allows the different types of values of the

multiple keys to be retrieved in a single operation:

bulkGet agg_key1, agg_key2, agg_key3;
returns { agg_key1: X1_int, agg_key2: X2_string, agg_key3:
X3_float }

In some embodiments, database agent 326 submits the qualified data access request to database agent 332 on cache data node 330. In some embodiments, cache data node 330 corresponds to cache data node 230 of FIG. 2. Database agent 336 of data node 330 is a software agent running on data node 330, such as a Memento™ memcar database agent.

In some embodiments, database agent 332 submits the data access request in the form of an API-based request, e.g., a put or a get, to key-value cache 334. If the data access request comprises a bulk get, database agent 332 may receive a plurality of aggregated values for a single key. In some embodiments, if the data access request is a bulk put, wherein aggregated values are submitted to the key-value cache 334 for insertion, the system service is responsible for constructing the data access request.

In some embodiments, database agent 332 receives data from key-value cache 334 and returns it to router database agent 326, which in turn returns the data to the system service.

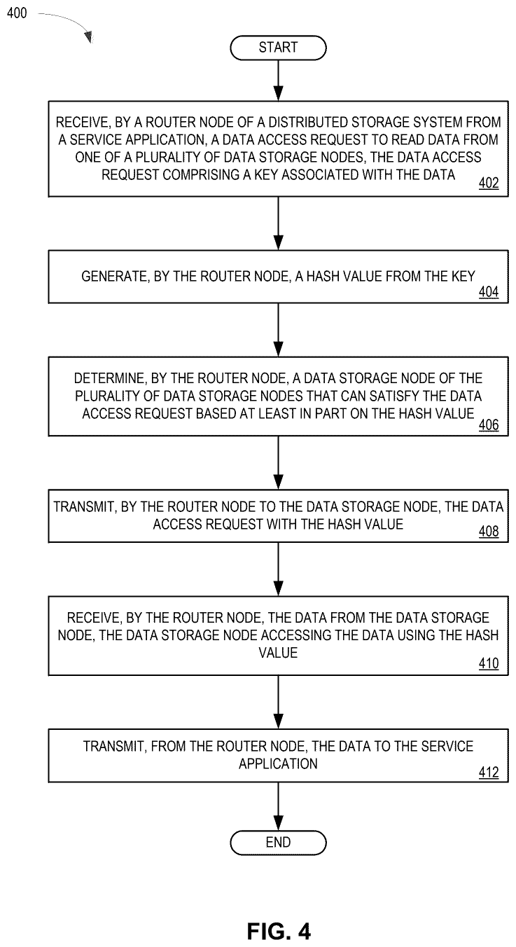

FIG. 4 is a flow diagram of a process 400 for executing, in an embodiment, a data access request from a service application to a data storage node, as routed by a router application. In some embodiments, a data storage node corresponds to a cache data node 230 as shown in FIG. 2. In some embodiments, process 400 is performed by processing logic that may comprise hardware (circuitry, dedicated logic, etc.), software (such as is run on a general-purpose computer system or a dedicated machine), firmware, or a combination. In some embodiments, the process 400 applies zone-based affinity to direct requests to the cache data nodes of a particular zone.

Referring to FIG. 4, processing logic begins at processing block 402, by receiving, by a router node of a distributed storage system from a service application, a data access request to read data from one of a plurality of data storage nodes, the data access request comprising a key associated with the data. In some embodiments, a portion of the key allows the router to apply zone-based affinity to direct requests to the cache data nodes of a particular zone. In some embodiments, a data storage node corresponds to a cache data node, such as cache data node 230 in FIG. 2. In some embodiments, a service application corresponds to service system 108 as shown in FIG. 1 or service 210 as shown in FIG. 2.

Processing logic then generates, by the router node, a hash value from the key (processing block 404). In some embodiments, a router SDK is used to generate a message containing the data access request, including the key and one or more identifiers that define what user and/or entity initiated the request. In some embodiments, the key itself contains identifiers, e.g., partial keys, that define what user and/or entity initiated the request. In some embodiments, these identifiers include the end-user, service system, or user group that initiated the request. The router SDK, in some embodiments, is a Memento™ router SDK that includes functions for accessing the services of a router application.

Processing logic determines, by the router node, a data storage node of the plurality of data storage nodes that can satisfy the data access request (processing block 406). As discussed herein, in some embodiments, processing logic uses a deterministic technique, such as the jump hash technique, to determine from among a set of distributed cache data nodes associated with a service's data, which specific cache data node contains the data associated with the key. In some embodiments, if an affinity zone is associated with the determined data storage node, and either the affinity zone or determined data storage node is unavailable, the processing logic can determine an alternative data storage node that can satisfy the data access request. In some embodiments, affinity zone information is obtained from a topology file, such as topology file 222 of FIG. 2.

Processing logic then transmits, by the router application to the data storage node, the data access request with the hash value (processing block 408). In some embodiments, the data storage node is a cache data node that is remote to the service node and/or the router node and the router transmits the data access request over a communications network to the data storage node.

At processing block 410, processing logic causes the router node to receive data from the data storage node, the data storage node accessing the data using the hash value.

At processing block 412, processing logic causes the router node to transmit the data retrieved from the data storage node to the service application to satisfy the original data access request received in processing block 402.

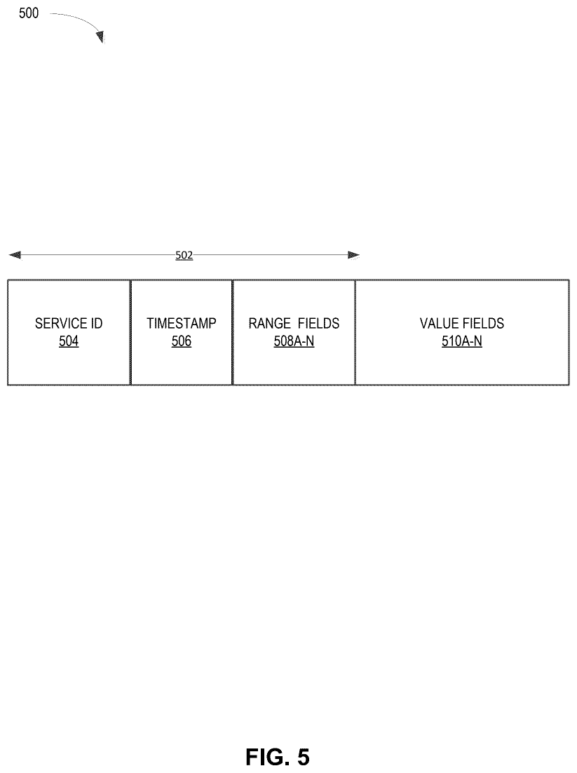

FIG. 5 is a diagram of an example data record 500 comprising a partial key that can contribute to a range query. In some embodiments, data record 500 is implemented on a cache data node similar to cache data node 330 of FIG. 3.

In the example, record 500 comprises a partial key 502 that comprises service-id 504, timestamp 506, and range fields 508A-N. Range fields 508A-N may be a variety of different field types, such as an operation field identifying an operation associated with data, a metadata field identifying one or more characteristics of the data, or other field types. Also part of record 500 is a set of value fields 510A-N.

Partial key 502 allows a hash to be created for the combination of service-id 504, timestamp 506, and range fields 508A-N, such that a range query can be performed that returns a set of records satisfying the query rather than having to retrieve all records, including extraneous records, for the service-id 504 and filtering them either at the router or service. In some embodiments, a bulk put operation results in associating multiple value fields 510A-N with a partial key 502. In some embodiments, the fields comprising the partial key 502 are adjusted to accommodate particular queries.

In some embodiments, a router service, such as router service 320 of FIG. 3, can examine a partial key included in a data access request so as to route the data access request to a particular cache data node, such as cache data node 330 of FIG. 3.

In some embodiments, partial keys comprising a time component can be routed to particular storage buckets within particular cache data nodes, further optimizing data retrieval. In an embodiment, a storage bucket may be defined to hold a predetermined amount of time's worth of database transactions, e.g., five-minute buckets. By limiting a query to a set of storage buckets, input/output (I/O) operations can be potentially reduced, leading to further reductions in computing cost and database transaction time. For example, a query for one hour's worth of data, comprising 1000 database transactions, could be satisfied with 12 queries (using the partial key and time buckets) rather than 1000 (using a full key).

In some embodiments, a particular user, service, service node, or router node may wish to send data access requests to a particular zone, e.g., a local zone, or even a particular cache data node within the local zone. In some embodiments, zone-based affinity can improve system performance by reducing the effects of network latency and reducing the overall time for a database transaction to complete. In some embodiments, zone-based affinity can allow particular database transactions to be routed to more powerful computing resources, also contributing to a reduced overall database transaction time. In some embodiments, by reducing the routing time, more time can be allocated for other processing, e.g., database transaction validation and authorization. In the event that the preferred cache data node in the local zone is unavailable, the data access request can be sent to an alternative cache data node in the local node. In the event that all cache data nodes in the local zone are unavailable, the data access request can be sent to a cache data node in another zone. In some embodiments, zone-based affinity can also reduce the number of data accesses needed to retrieve a large volume of data, by collocating the data within a particular zone. In some embodiments, colocation is based on a user-id, such that all data associated with a particular user-id is stored in a particular (local) affinity zone and replicated across cache data nodes within that local zone. In some embodiments, the data is also replicated from the local zone to other zones.

In some embodiments, an affinity zone is a building or data center, e.g., Zone A corresponds to Building One, Zone B corresponds to Building Two, and Zone C corresponds to Building Three. Referring to the cache data nodes illustrated in FIG. 2, in the embodiment, the Zone A cache data nodes are located in Building One, the Zone B cache data nodes are located in Building Two, and the Zone C cache data nodes are located in Building Three. Also referring to FIG. 2, in some embodiments, the topology files 222 can specify zone-based affinity for users, services, or use other criteria to designate a preferred zone. In some embodiments, zone-based affinity can obviate the need to calculate a hash value to identify a preferred cache data node.

In some embodiments, if the local zone cache data node(s) crash or otherwise become unavailable, data access requests can be routed to an alternative zone. In some cases, data access times may increase, but the data remains available. In an example, if the cache data nodes in Zone A become unavailable, data can be retrieved from the cache data nodes in Zone B.

In the event the one or more cache data nodes in Zone A fail, in some embodiments, the routers are informed and subsequently reroute data access requests intended for Zone A to alternative cache data nodes. New instances are created to replace the failed instances and the new instances are populated by copying data from the alternative cache data nodes. In some embodiments, the routers are informed that the new instances are in “cache-warming” or write-only mode. In some embodiments, instances in “cache-warming” mode are only sent data access requests that involve writes. Data access requests that involve reads are rerouted to alternative cache data nodes in other zones. In some embodiments, when the new instances are fully populated, the routers are so informed and return to routing data access requests to cache data nodes in the local zone.

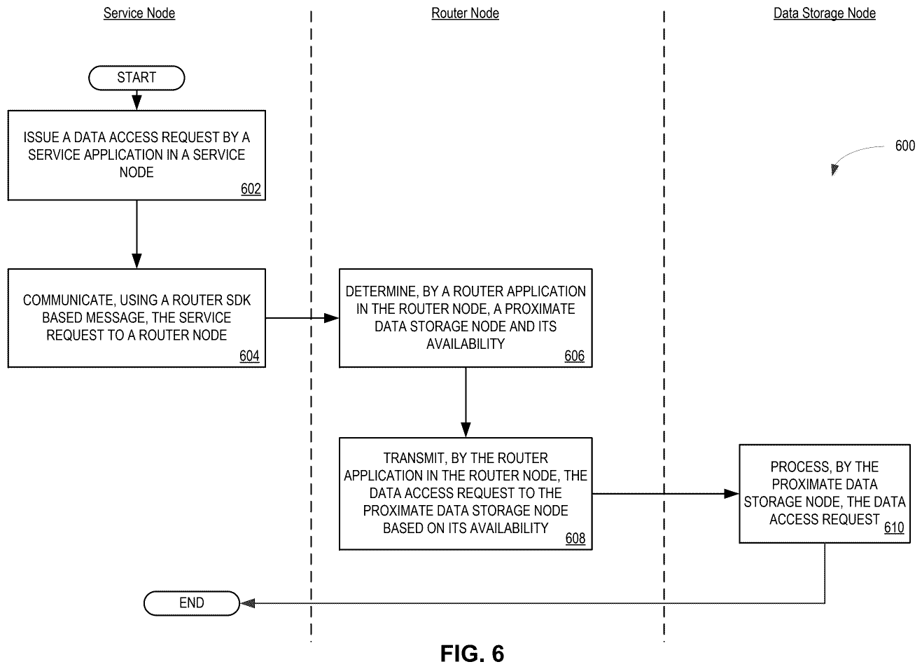

FIG. 6 is a flow diagram of a process 600 for executing, in an embodiment, a data access request from a service application, to a cache data node, as directed by a router application. The process 600 is performed by processing logic that may comprise hardware (circuitry, dedicated logic, etc.), software (such as is run on a general-purpose computer system or a dedicated machine), firmware, or a combination. In some embodiments, the process 600 employs zone-based affinity to direct requests to the cache data nodes of a particular zone.

Referring to FIG. 6, processing logic of a service node begins by receiving a data access request by a service application, the request including at least a key for data subject to the request (processing block 602). The key may be derived from the data subject to the request, such as by hashing the data, a portion of the data, or a portion of the data combined with additional data, e.g., a salt. The key serves as an identifier, index, etc. of the data subject to the data access request, and as discussed herein is used to determine how to route data access requests. In some embodiments, as discussed herein, additional data may also be included in the request, as well as the requested data access operation, e.g., access store data, write data, overwrite data, delete data, move data, or replicate data.

Processing logic then communicates, using a router SDK based message, the service request to a router application including at least a requested operation and the key (processing block 604). The router SDK, as discussed herein, is a set of router messaging functions that enables the service to issue data access requests in way that interpretable by a router application. For example, the SDK formats the message, generates a message payload, and uses appropriate functions to communicate the message to a router application.

Processing logic then determines, by a router application on the router node, a proximate data storage node and its availability (processing block 606). In some embodiments, the router application determines that the message should be routed to a particular cache data node in a particular zone, based on zone-based affinity instructions. In some embodiments, the router application makes this determination by examining a portion of the record's key. In some embodiments, a record's key comprises multiple partial keys, which can be examined by the router application as part of its determination of the destination of the message.

In some embodiments, processing logic determines the cache data node to which the data access request should be directed based on the supplied key. The router application, as discussed herein, determines based on the key and cached data nodes associated with a requesting service/user/user group in which cache data node from a set of nodes the data associated with the key is located. For example, processing logic may use the jump hash technique as a deterministic node selection technique using the key as an input to a jump hash process that generates an index to a location, within a data storage node, a data access request is to be routed. Once the appropriate node is selected, processing logic utilizes a distributed routing logic of the Memento™ memrouter to generate a network-based memory access message directed to the selected remote cache data node.

Processing logic transmits, by the router application in the router node, the data access request to the proximate data storage node, based on its availability (processing block 608). The transmission includes the sending of the message over a communications network. In some embodiments, the message may be encrypted prior to transmission to secure the message contents.

Processing logic then processes, at the data storage node, the data access request (processing block 610). The data storage node can be remote to the router node, and thus receives a network-based message. Upon completion of the data access request at the data storage node, processing logic returns the results of the data access result to the requesting service application at the service node.

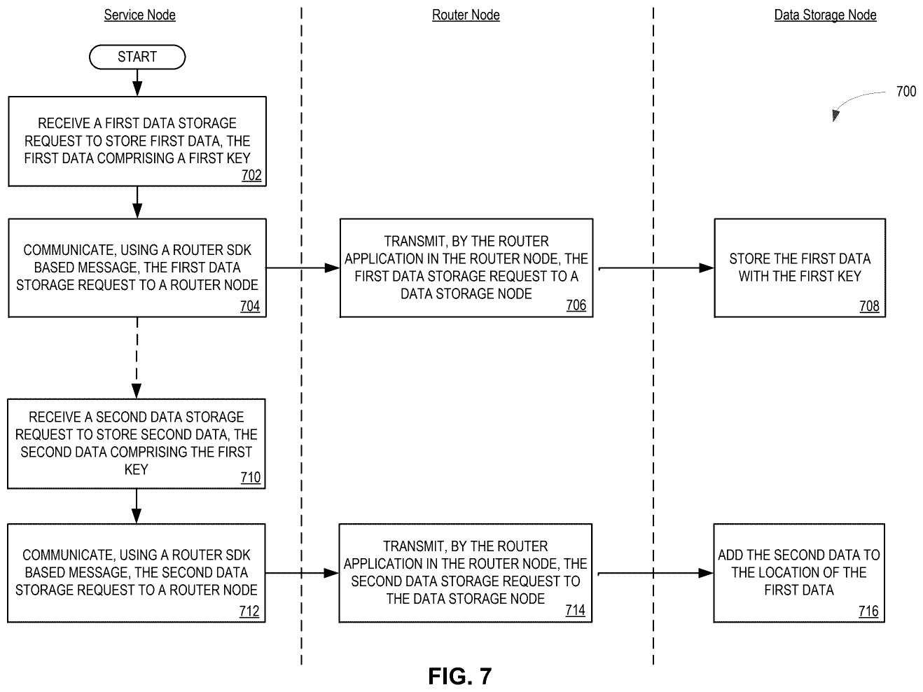

FIG. 7 is a flow diagram of a process 700 for executing, in an embodiment, a data access request from a service application, to a cache data node, as directed by a router application. In some embodiments, process 700 is performed by processing logic that may comprise hardware (circuitry, dedicated logic, etc.), software (such as is run on a general-purpose computer system or a dedicated machine), firmware, or a combination. In some embodiments, the process 700 employs zone-based affinity to direct requests to the cache data nodes of a particular zone.

Referring to FIG. 7, processing logic of a service node begins by receiving a first data storage request to store a first block of data, the first block of data comprising a first key (processing block 702). The key may be derived from the data subject to the request, such as by hashing the data, a portion of the data, or a portion of the data combined with additional data, e.g., a salt. The key serves as an identifier, index, etc. of the data subject to the data access request, and as discussed herein is used to determine how to route data access requests. In some embodiments, as discussed herein, additional data may also be included in the request, as well as the requested data access operation, e.g., access store data, write data, overwrite data, delete data, move data, or replicate data.

Processing logic then communicates, using a router SDK based message, the first data storage request to a router application at a router node (processing block 704). The router SDK, as discussed herein, is a set of router messaging functions that enables the service to issue data access requests in way that interpretable by a router application. For example, the SDK formats the message, generates a message payload, and uses appropriate functions to communicate the message to a router application.

Processing logic then transmits, by the router application at the router node, the first data storage request to a data storage node (processing block 706). Processing logic determines, by the router application on the router node, a proximate data storage node and its availability. In some embodiments, the router application determines that the message should be routed to a particular cache data node in a particular zone, based on zone-based affinity instructions. In some embodiments, the router application makes this determination by examining a portion of the record's key. In some embodiments, a record's key comprises multiple partial keys, which can be examined by the router application as part of its determination of the destination of the message.

Processing logic then causes the data storage node to store the first data with the first key (processing block 708). Upon completion of the data access request at the data storage node, processing logic returns the results of the data access result to the requesting service application at the service node.

Returning to the service node, processing logic receives a second data storage request to store a second block of data, the second block of data comprising the first key (processing block 710). The key may be derived from the data subject to the request, such as by hashing the data, a portion of the data, or a portion of the data combined with additional data, e.g., a salt. The key serves as an identifier, index, etc. of the data subject to the data access request, and as discussed herein is used to determine how to route data access requests. In some embodiments, as discussed herein, additional data may also be included in the request, as well as the requested data access operation, e.g., access store data, write data, overwrite data, delete data, move data, or replicate data.

Processing logic then communicates, using a router SDK based message, the second data storage request to a router application at a router node (processing block 712). In some embodiments, the router node will be the same router node determined in processing block 704.

Processing logic then transmits, by the router application at the router node, the second data storage request to a data storage node (processing block 714). In some embodiments, the data storage node will be the same data storage node used for the first data storage request. In some embodiments, the router application determines that the message should be routed to a particular cache data node in a particular zone, based on zone-based affinity instructions. In some embodiments, the router application makes this determination by examining a portion of the record's key. In some embodiments, a record's key comprises multiple partial keys, which can be examined by the router application as part of its determination of the destination of the message.

Processing logic then causes the data storage node to add the second data block to the location of the first data block (processing block 716). In some embodiments, this is accomplished using a put operation, the put operation using the second data request's key, which is the same key comprised in the first data storage request. In some embodiments, processing logic aggregates the data of the first data storage request and the data of the second data storage request with the first key.

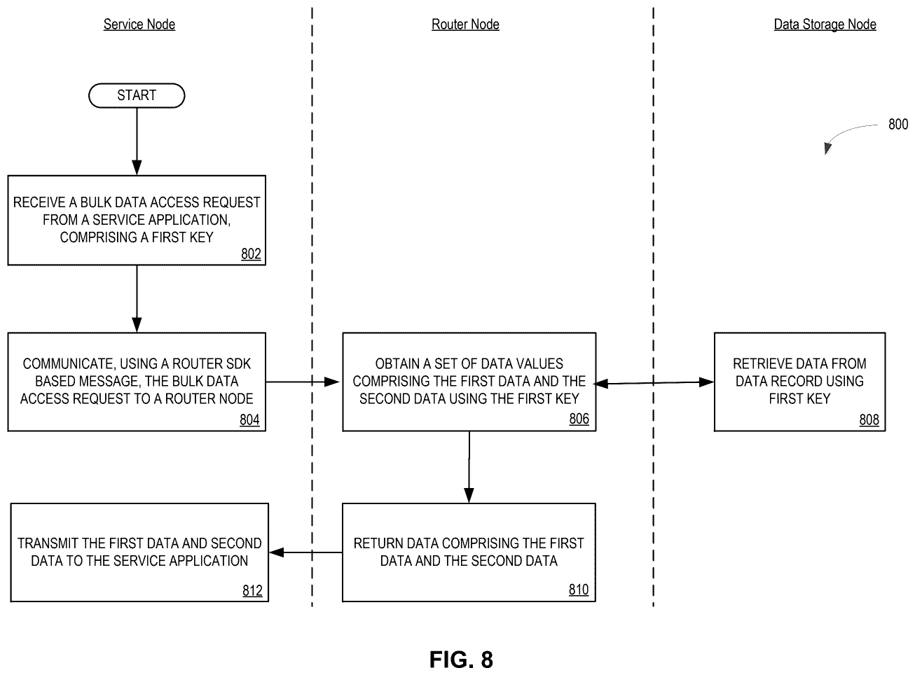

FIG. 8 is a flow diagram of a process 800 for executing, in an embodiment, a data access request by a router application, received from a service application, to a data storage node. In some embodiments, process 800 is performed by processing logic that may comprise hardware (circuitry, dedicated logic, etc.), software (such as is run on a general-purpose computer system or a dedicated machine), firmware, or a combination. In some embodiments, the process 800. In some embodiments, the process 800 employs zone-based affinity to direct requests to the cache data nodes of a particular zone.

Referring to FIG. 8, processing logic of a service node begins by receiving a bulk data access request from a service application, the request comprising a first key (processing block 802). The key may be derived from the data subject to the request, such as by hashing the data, a portion of the data, or a portion of the data combined with additional data, e.g., a salt. The key serves as an identifier, index, etc. of the data subject to the data access request, and as discussed herein is used to determine how to route data access requests. In some embodiments, as discussed herein, additional data may also be included in the request, as well as the requested data access operation, e.g., access store data, write data, overwrite data, delete data, move data, or replicate data. In some embodiments, the key represents a partial key, combining a subset of fields of a record comprising the data access request. In some embodiments, the key is associated with a plurality of data fields, retrievable in a single operation with the key.

In some embodiments, the request comprises a first key and a second key, where the two keys represent inputs to a range query. In some embodiments, the resulting data is returned as a bulk get.

Processing logic then causes the service node to communicate, using a router SDK based message, the bulk data access request to a router application on a router node (processing block 804). The router SDK, as discussed herein, is a set of router messaging functions that enables the service to issue data access requests in way that interpretable by a router application. For example, the SDK formats the message, generates a message payload, and uses appropriate functions to communicate the message to a router application.

Processing logic, at processing block 806, then causes the router node to obtain a set of data values, e.g., a first data and a second data, associated with the first key. Processing logic determines, by the router application on the router node, a proximate data storage node and its availability. In some embodiments, the router application determines that the message should be routed to a particular cache data node in a particular zone, based on zone-based affinity instructions. In some embodiments, the router application makes this determination by examining a portion of the record's key. In some embodiments, a record's key comprises multiple partial keys, which can be examined by the router application as part of its determination of the destination of the message.

Processing logic then causes the data storage node to retrieve the data using the first key and return it to the router application on the router node (processing block 808). In some embodiments, a bulk get operation allows multiple values associated with one key or multiple keys to be retrieved in a single operation. In some embodiments, keys that refer to a set of values may be associated with time values, e.g., buckets of values associated with a time interval. Then, a bulk get specifying a set of keys can correspond to a range query over a period of time, e.g., a query for data values over an hour period, a day, etc. By returning the sets of data associated with the keys, time-based range value queries can be enabled in a distributed key-value data store.

Processing logic then causes the router node to return, to the service node, data comprising the first data and the second data (processing block 810). In some embodiments, if multiple values associated with one or multiple keys are retrieved, the multiple values are separated with delimiters so that the service application can easily obtain the individual data elements. In some embodiments, the delimited data is obtained as such directly from the cache data node.

Processing logic then causes the service node, in turn, to transmit the first data block and the second data block to the service application that originally issued the data access request (processing block 812).

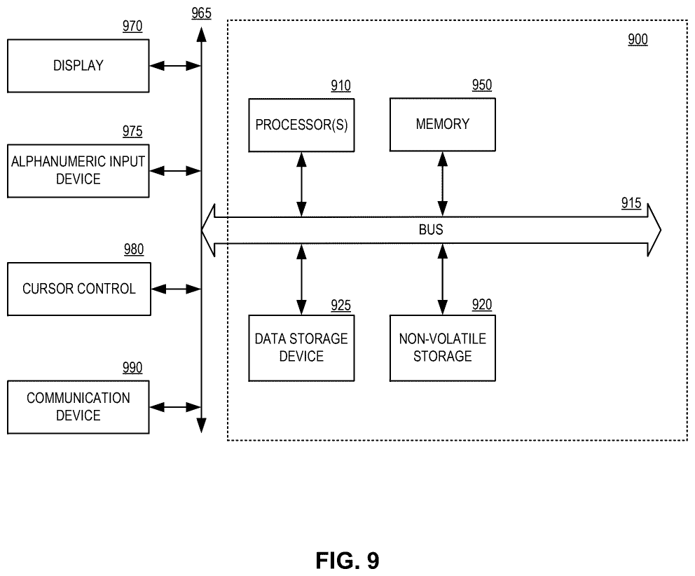

FIG. 9 is an embodiment of a computer system that may be used to support the systems and operations discussed herein. For example, the computer system illustrated in FIG. 9 may be used by a commerce platform system, a development system, user system, etc. It will be apparent to those of ordinary skill in the art, however that other alternative systems of various system architectures may also be used.

The data processing system illustrated in FIG. 9 includes a bus or other internal communication means 915 for communicating information, and a processor 910 coupled to the bus 915 for processing information. The system further comprises a random-access memory (RAM) or other volatile storage device 950 (referred to as memory), coupled to bus 915 for storing information and instructions to be executed by processor 910. Main memory 950 also may be used for storing temporary variables or other intermediate information during execution of instructions by processor 910. The system can also comprise non-volatile storage 920, such as a read-only memory (ROM) and/or static storage device coupled to bus 915 for storing static information and instructions for processor 910, and a data storage device 925 such as a magnetic disk or optical disk and its corresponding disk drive. Data storage device 925 can be coupled to bus 915 for storing information and instructions.

The system may further be coupled to a display device 970, such as a light emitting diode (LED) display or a liquid crystal display (LCD) coupled to bus 915 through bus 965 for displaying information to a computer user. An alphanumeric input device 975, including alphanumeric and other keys, may also be coupled to bus 915 through bus 965 for communicating information and command selections to processor 910. An additional user input device is cursor control device 980, such as a touchpad, mouse, a trackball, stylus, or cursor direction keys coupled to bus 915 through bus 965 for communicating direction information and command selections to processor 910, and for controlling cursor movement on display device 970.

Another device, which may optionally be coupled to computer system 900, is a communication device 990 for accessing other nodes of a distributed system via a network. The communication device 990 may include any of a number of commercially available networking peripheral devices such as those used for coupling to an Ethernet, token ring, Internet, or wide area network. The communication device 990 may further be a null-modem connection, or any other mechanism that provides connectivity between the computer system 900 and the outside world. Note that any or all of the components of this system illustrated in FIG. 9 and associated hardware may be used in various embodiments as discussed herein.

It will be appreciated by those of ordinary skill in the art that any configuration of the system may be used for various purposes according to the particular implementation. The control logic or software implementing the described embodiments can be stored in memory 950, data storage device 925, or another storage medium locally or remotely accessible to processor 910.

It will be apparent to those of ordinary skill in the art that the system, method, and process described herein can be implemented as software stored in memory 950 or read-only memory 920 and executed by processor 910. This control logic or software may also be resident on an article of manufacture comprising a computer readable medium having computer readable program code embodied therein and being readable by the mass storage device 925 and for causing the processor 910 to operate in accordance with the methods and teachings herein.

The embodiments discussed herein may also be embodied in a handheld or portable device containing a subset of the computer hardware components described above. For example, the handheld device may be configured to contain only the bus 915, the processor 910, and memory 950 and/or 925. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 910, a data storage device 925, a bus 915, and memory 950, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

1. A method for executing data access requests in a distributed storage system, comprising:
receiving, by a router node of a distributed storage system from a service application, a data access request to read data from one of a plurality of data storage nodes, the data access request comprising a key associated with the data, and the data storage nodes comprising key-value data stores;
generating, by the router node, a hash value from a subset of fields of the key;
determining, by the router node, a data storage node of the plurality of data storage nodes that can satisfy the data access request based at least in part on the hash value generated from the subset of fields of the key;
transmitting, by the router node to the data storage node, a bulk get data access request with the hash value, wherein the bulk get requests retrieval of multiple data in a single request using the same hash value generated from the subset of fields of the key;
receiving, by the router node, a plurality of data from the data storage node, the data storage node accessing each of the plurality of data using the hash value; and
transmitting, from the router node, the plurality of data to the service application.

2. The method of claim 1, wherein the data storage node is determined by the router node based at least in part on a relative ordering of preference of the plurality of data storage nodes.

3. The method of claim 2, wherein the relative ordering of preference is defined by the service application prior to receipt of the data access request by the router node.

4. The method of claim 2, wherein the relative ordering of preference is defined based on geographic proximity between a location of a computing system that executes the service application and geographic locations associated with each of the plurality of data storage nodes, and the data storage node is determined by the router node as having a minimal geographic proximity among the plurality of data storage nodes

5. The method of claim 2, further comprising:
determining, by the router node, that the data storage node is unavailable;
determining, by the router node, an alternate data storage node based on the relative ordering of preference of the plurality of data storage nodes; and
transmitting, by the router node, the data access request to the alternate data storage node.

6. The method of claim 5, wherein the plurality of data storage nodes are comprised in a set of zones, and each zone in the set of zones comprises a subset of plurality of nodes, and the method further comprises:
determining, by the router node, the alternate data storage node based on the relative ordering of preference of the plurality of data storage nodes and a zone from the set of zones to which the data storage node belongs.

7. The method of claim 5, wherein the data storage node is determined to be unavailable in response to a detection that cache warming is being performed on the data storage node.

8. The method of claim 1, wherein the key is formed from a set of service system data, and the method further comprises:
receiving, by the router node of the distributed storage system from the service application, a second data access request to read second data from one of a plurality of storage nodes, the data access request comprising the key associated with the second data; and
accessing, by the router node, the second data using the hash value generated from the key and based on the determination of the data storage node.

9. The method of claim 1, wherein the distributed storage system stores data of a plurality of distributed service applications in cache of the plurality of data storage nodes.

10. A system, comprising:
a memory having instructions stored thereupon; and
one or more processors coupled with the memory, configured to execute the instructions, causing the one or more processors to perform operations, comprising:
receiving, by a router node of a distributed storage system from a service application, a data access request to read data from one of a plurality of data storage nodes, the data access request comprising a key associated with the data, and the data storage nodes comprising key-value data stores;
generating, by the router node, a hash value from a subset of fields of the key;
determining, by the router node, a data storage node of the plurality of data storage nodes that can satisfy the data access request based at least in part on the hash value generated from the subset of fields of the key;
transmitting, by the router node to the data storage node, a bulk get data access request with the hash value; wherein the bulk get requests retrieval of multiple data in a single request using the same hash value generated from the subset of fields of the key;
receiving, by the router node, a plurality of data from the data storage node, the data storage node accessing each of the plurality of data using the hash value; and
transmitting, from the router node, the plurality of data to the service application.

11. The system of claim 10, wherein the data storage node is determined by the router node based at least in part on a relative ordering of preference of the plurality of data storage nodes.

12. The system of claim 11, wherein the relative ordering of preference is defined by the service application prior to receipt of the data access request by the router node.

13. The system of claim 11, wherein the relative ordering of preference is defined based on geographic proximity between a location of a computing system that executes the service application and geographic locations associated with each of the plurality of data storage nodes, and the data storage node is determined by the router node as having a minimal geographic proximity among the plurality of data storage nodes.

14. The system of claim 11, further comprising:
determining, by the router node, that the data storage node is unavailable;
determining, by the router node, an alternate data storage node based on the relative ordering of preference of the plurality of data storage nodes; and
transmitting, by the router node, the data access request to the alternate data storage node.

15. The system of claim 14, wherein the plurality of data storage nodes are comprised in a set of zones, and each zone in the set of zones comprises a subset of plurality of nodes, and the operations further comprise:
determining, by the router node, the alternate data storage node based on the relative ordering of preference of the plurality of data storage nodes and a zone from the set of zones to which the data storage node belongs.

16. A non-transitory computer readable storage media having instructions stored thereupon which, when executed by a system having at least a processor and a memory therein, cause the processor to perform operations for executing data access requests in a distributed storage system, comprising:
receiving, by a router node of a distributed storage system from a service application, a data access request to read data from one of a plurality of data storage nodes, the data access request comprising a key associated with the data, and the data storage nodes comprising key-value data stores;
generating, by the router node, a hash value from a subset of fields of the key;
determining, by the router node, a data storage node of the plurality of data storage nodes that can satisfy the data access request based at least in part on the hash value generated from the subset of fields of the key;
transmitting, by the router node to the data storage node, a bulk get data access request with the hash value, wherein the bulk get requests retrieval of multiple data in a single request using the same hash value generated from the subset of fields of the key;
receiving, by the router node, a plurality of data from the data storage node, the data storage node accessing each of the plurality of data using the hash value; and
transmitting, from the router node, the plurality of data to the service application.

17. The non-transitory computer readable storage media of claim 16, wherein the data storage node is determined by the router node based at least in part on a relative ordering of preference of the plurality of data storage nodes.

18. The non-transitory computer readable storage media of claim 17, wherein the relative ordering of preference is defined by the service application prior to receipt of the data access request by the router node.

19. The non-transitory computer readable storage media of claim 17, wherein the relative ordering of preference is defined based on geographic proximity between a location of a computing system that executes the service application and geographic locations associated with each of the plurality of data storage nodes, and the data storage node is determined by the router node as having a minimal geographic proximity among the plurality of data storage nodes.

20. The non-transitory computer readable storage media of claim of claim 17, the operations further comprising:
determining, by the router node, that the data storage node is unavailable;
determining, by the router node, an alternate data storage node based on the relative ordering of preference of the plurality of data storage nodes; and
transmitting, by the router node, the data access request to the alternate data storage node.
